(19) United States
(12) Patent Application Publication
(10) Pub. No.: US 2013/0220382 A1
(43) Pub. Date: Aug. 29, 2013

(54) SUBSTRATE PROCESSING METHOD

(71) Applicant: EBARA CORPORATION, (US)

(72) Inventors: Akira FUKUDA, Tokyo (JP); Akira FUKUNAGA, Tokyo (JP)

(73) Assignee: EBARA CORPORATION, Tokyo (JP)

(21) Appl. No.: 13/764,876

(22) Filed: Feb. 12, 2013

(30) Foreign Application Priority Data
Feb. 24, 2012 (JP) 2012-38800
Dec. 6, 2012 (JP) 2012-267106

(51) Int. Cl. B08B 3/04

(52) U.S. Cl. CPC B08B 3/04
USPC 134/33

(57) ABSTRACT

There is provided a substrate processing method which can keep a surface of a substrate, which has hydrophobic properties, completely wet with a processing liquid during liquid processing, thereby preventing the formation of watermarks on the surface of the substrate. The substrate processing method for processing a substrate by supplying a processing liquid to a central portion of a surface of the substrate rotating horizontally, includes: determining the rotational speed of the substrate and the flow rate of the processing liquid when supplied to the surface of the substrate from a relationship between the rotational speed of the substrate and the flow rate of the processing liquid when supplied to the surface of the substrate, said relationship being dependent on the contact angle of the processing liquid with respect to the surface of the substrate and being capable of preventing partial draining of the processing liquid held on the surface of the substrate or partial drying of the surface of the substrate; and supplying the processing liquid to the central portion of the surface of the substrate at the determined flow rate while rotating the substrate at the determined rotational speed.

### CROSS REFERENCE TO RELATED APPLICATIONS

This document claims priorities to Japanese Patent Application No. 2012-38800, filed Feb. 24, 2012 and Japanese Patent Application No. 2012-267106, filed Dec. 6, 2012, the entire contents of which are hereby incorporated by reference.

### BACKGROUND OF THE INVENTION

1. Field of the Invention

The present invention relates to a substrate processing method for carrying out predetermined processing of a surface of a substrate by supplying a processing liquid to the surface of the substrate while rotating the substrate, and more particularly to a substrate processing method which comprises supplying a cleaning liquid (liquid chemical) to a surface of a rotating substrate to clean the surface or supplying a rinsing liquid to a surface of a rotating substrate to rinse off a cleaning liquid (liquid chemical) remaining on the surface, and thereafter drying the surface of the substrate by rotating the substrate. The substrate processing method of the present invention can be applied to liquid processing of a substrate, such as a semiconductor wafer, a glass photomask substrate, a glass substrate for a liquid crystal display, a substrate for an FED (field emission display), an optical disk substrate, a magnetic disk substrate or a magnet-optical disk substrate.

2. Description of the Related Art

As semiconductor devices are becoming finer these days, cleaning of various films, made of materials having different physical properties and formed in a surface of a substrate, is widely practiced. When chemical processing of a surface of a substrate using a liquid chemical, such as cleaning using a cleaning liquid, is performed, it is common practice to perform post-processing to remove the liquid chemical, such as a cleaning liquid, remaining on the surface of the substrate. The post-processing generally comprises rinsing the surface of the substrate with a rinsing liquid, such as pure water, followed by drying of the surface of the substrate. The cleaning of a surface of a substrate using a cleaning liquid includes scrub cleaning of the surface of the substrate carried out in the presence of a cleaning liquid (liquid chemical). It is known that when a surface of a substrate has hydrophobic properties, watermarks may be formed on the surface of the substrate after the post-processing process comprising the rinsing and drying steps.

In order to prevent the formation of watermarks on a surface of a substrate after drying, a method has been proposed which comprises rinsing a surface of a substrate, which has been treated with hydrofluoric acid, by supplying pure water to the surface of the substrate, replacing pure water remaining on the surface of the substrate with an aqueous solution of IPA (isopropyl alcohol), and then drying the surface of the substrate by rotating the substrate at a high speed (see patent document 1). According to patent document 1, the contact angle of aqueous solution of IPA, having a concentration of 10 vol. %, with respect to poly-Si is about 32°.

### PRIOR ART DOCUMENT

Patent document 1: Japanese Patent Laid-Open Publication No. 2009-110984

### SUMMARY OF THE INVENTION

There are cases where a surface of a substrate is not kept completely wet but partially dry during rinsing of the surface of the substrate, and droplets of a rinsing liquid remain on dry portions of the surface of the substrate. Watermarks are formed when the liquid droplets remaining on the surface of the substrate are drained off. Thus, in order to prevent the formation of watermarks on a surface (processed surface) of a substrate after drying, it is important to keep the surface of the substrate completely wet (without a dry portion) with a rinsing liquid.

However, a method has not been fully established which can keep a surface of a substrate, which has hydrophobic properties, completely wet with a rinsing liquid during rinsing of the surface of the substrate. Also for various other types of liquid processing than rinsing, such as processing with a liquid chemical, it is important to prevent partial or local drying of a surface of a substrate in order to prevent the formation of watermarks.

The present invention has been made in view of the above situation. It is therefore an object of the present invention to provide a substrate processing method which can keep a surface of a substrate, which has hydrophobic properties, completely wet with a processing liquid during liquid processing, thereby preventing the formation of watermarks on the surface of the substrate.

It has been found through the present inventors' experimental studies that when a surface of a substrate is processed with a processing liquid by supplying the processing liquid to a central portion of the surface of the substrate while rotating the substrate horizontally, partial draining of the processing liquid on the surface of the substrate or partial drying of the surface of the substrate during the processing can be prevented by determining the rotational speed of the substrate and the flow rate of the processing liquid when it is supplied to the surface of the substrate in such a manner that they satisfy a specific relation which is dependent on the contact angle of the processing liquid with respect to the surface of the substrate.

FIG. 1 is a graph showing those relations between the rotational speed of a substrate and the flow rate of a processing liquid which are necessary to completely wet a surface (upper surface) of the substrate with the processing liquid during processing, as determined experimentally for varying contact angles θ (30°, 45°, 60° and)75° of the processing liquid with respect to the surface of the substrate (hereinafter sometimes referred to simply as “contact angle(s) θ”) when the processing is carried out in the following manner: While rotating a circular resin substrate having a diameter of 450 mm in a horizontal position, a processing liquid is supplied from a straight nozzle, located just above the center of rotation of the substrate, vertically downward onto the surface of the substrate.

Referring to FIG. 1, the surface of the substrate is kept completely wet with the processing liquid if a point on the graph, corresponding to the substrate rotational speed/liquid flow rate conditions used, lies within the area on the upper right side of a curved line corresponding to the contact angle θ of the processing liquid used. It will be appreciated that those conditions for completely wetting the surface of the 450-mm substrate with a processing liquid, corresponding to the area on the upper right side of the relevant curved line of FIG. 1, also apply to substrates having a diameter of less than 450 mm. Referring to FIG. 1, the contact angle of the processing liquid with respect to the surface of the substrate is changed by changing the concentration of the processing liquid.

As can be seen in FIG. 1, conditions (the rotational speed of a substrate and the flow rate of a processing liquid when supplied to a surface of a substrate) for completely wetting a surface of a substrate with a processing liquid depend largely on the contact angle of the processing liquid with respect to the surface of the substrate. It has been confirmed that the height of the straight nozzle from a surface of a substrate is of little relevance to the results of FIG. 1.

Compared to the case where a processing liquid is supplied vertically downward to the center of rotation of a substrate, milder conditions can be used for completely wetting the surface of the substrate with the processing liquid in the case where the processing liquid is supplied to the center of rotation of the substrate at an angle with respect to the vertical. Thus, when a processing liquid is supplied to around the center of rotation of a substrate at an angle with respect to the vertical, the surface of the substrate can be completely wetted with the processing liquid if the conditions used meet the requirement shown in FIG. 1. In other words, if a processing liquid is supplied to around the center of rotation of a substrate under conditions which meet the requirement shown in FIG. 1, then the surface of the substrate can be completely wetted with the processing liquid regardless of the angle of the processing liquid, when it is supplied to the surface of the substrate, with respect to the vertical.

Based on the above findings, the present invention provides a substrate processing method for processing a substrate by supplying a processing liquid to a central portion of a surface of the substrate rotating horizontally, said method comprising: determining the rotational speed of the substrate and the flow rate of the processing liquid when supplied to the surface of the substrate from a relationship between the rotational speed of the substrate and the flow rate of the processing liquid when supplied to the surface of the substrate, said relationship being dependent on the contact angle of the processing liquid with respect to the surface of the substrate and being capable of preventing partial draining of the processing liquid held on the surface of the substrate or partial drying of the surface of the substrate; and supplying the processing liquid to the central portion of the surface of the substrate at the determined flow rate while rotating the substrate at the determined rotational speed.

When the contact angle of the processing liquid with respect to the surface of the substrate is not more than 30°, the rotational speed N (rpm) of the substrate and the flow rate Q (L/min) of the processing liquid when supplied to the surface of the substrate may satisfy, for example, the following relation:

Q>30000×(N−35)^{-2.2}+0.15

When the contact angle of the processing liquid with respect to the surface of the substrate is not more than 45°, the rotational speed N (rpm) of the substrate and the flow rate Q (L/min) of the processing liquid when supplied to the surface of the substrate may satisfy, for example, the following relation:

Q>20×(N−100)^{-0.8}+0.45

When the contact angle of the processing liquid with respect to the surface of the substrate is not more than 60°, the rotational speed N (rpm) of the substrate and the flow rate Q (L/min) of the processing liquid when supplied to the surface of the substrate may satisfy, for example, the following relation:

Q>37000×(N−254)^{-1.7}+0.65

When the contact angle of the processing liquid with respect to the surface of the substrate is not more than 75°, the rotational speed N (rpm) of the substrate and the flow rate Q (L/min) of the processing liquid when supplied to the surface of the substrate may satisfy, for example, the following relation:

Q>790×(N−330)^{-1.5}+1

The processing liquid may be a cleaning liquid for cleaning the surface of the substrate, a rinsing liquid for rinsing off a cleaning liquid remaining on the surface of the substrate after cleaning, or a replacement liquid to be replaced with a rinsing liquid on the surface of the substrate. An aqueous solution of IPA (isopropyl alcohol), for example, may be used as the replacement liquid.

In a preferred aspect of the present invention, the substrate processing method further comprises the step of drying the surface of the substrate after the liquid processing by rotating the substrate.

The present inventors have found that in the drying step of drying the surface of the substrate by rotating the substrate, appropriate drying conditions (rotational speed of the substrate) exist depending on the contact angle of the processing liquid, remaining on the surface of the substrate, with respect to the surface of the substrate.

FIG. 2 is a graph showing three different types of the behavior of a processing liquid on a surface of a substrate upon drying of the surface of the substrate, determined by a relationship between the rotational speed of the substrate and the contact angle of the processing liquid with respect to the surface of the substrate and observed when the substrate is processed in the following manner: While rotating a circular resin substrate having a diameter of 450 mm in a horizontal position, a processing liquid is supplied from a straight nozzle, located just above the center of rotation of the substrate, vertically downward onto the surface of the substrate. After the supply of the processing liquid is stopped, the substrate is dried by rotating the substrate. The behavior of the processing liquid (liquid film) on the surface of the substrate is observed during drying of the substrate.

In both the type “a” and the type “b” shown in FIG. 2, a liquid film on a surface of a substrate becomes thin uniformly and an iridescent interference pattern is observed upon draining of the liquid film. Further, no liquid droplets are present on the surface of the substrate after the liquid film is drained off. This indicates that drying conditions, corresponding to the type “a” or the type “b”, are appropriate for prevention of the formation of watermarks. In the type “a”, as the entire liquid film becomes thin uniformly upon draining of the liquid film, numerous small holes come to be formed in the liquid film. In the type “b”, as the entire liquid film becomes thin uniformly upon draining of the liquid film, the liquid film takes on the form of numerous radial streaks. The type “b” is preferable to the type “a” for prevention of watermarks.

In the type “c”, on the other hand, a peripheral portion of a liquid film on a surface of a substrate breaks off to form a liquid string on the surface of the substrate, or holes are formed in the liquid film upon draining of the liquid film. Further, a large number of liquid droplets are present on the surface of the substrate after the liquid film is drained off. This indicates that the use of drying conditions, corresponding to the type “c”, will result in the formation of watermarks. It will be appreciated that also for a substrate having a diameter of less than 450 mm, the use of drying conditions, corresponding to the type “a” or the type “b” shown in FIG. 2, is appropriate for prevention of the formation of watermarks.

Referring to FIG. 2, the contact angle of the processing liquid with respect to a surface of a substrate is changed by changing the concentration of the processing liquid. It has been confirmed by a similar experiment, conducted using a different type of substrate and a different type of processing liquid, that the different processing liquid (liquid film) on the surface of the different substrate exhibits the same behavior as described above if the contact angle of the processing liquid with respect to the surface of the substrate is the same.

As will be appreciated from the foregoing, when the contact angle of the processing liquid, remaining on the surface of the substrate, with respect to the surface of the substrate is not less than 35° and less than 45°, the substrate is preferably rotated at a rotational speed of not less than 600 rpm in the drying step.

When the contact angle of the processing liquid, remaining on the surface of the substrate, with respect to the surface of the substrate is less than 35°, the substrate is preferably rotated at a rotational speed of not less than 200 rpm in the drying step.

Preferably, when the contact angle of the processing liquid, remaining on the surface of the substrate, with respect to the surface of the substrate is not less than 45°, the processing liquid is replaced with a replacement liquid having a contact angle of less than 45° with respect to the surface of the substrate, and then in the drying step the substrate is rotated either at a rotational speed of not less than 600 rpm when the contact angle of the replacement liquid with respect to the surface of the substrate is not less than 35° and less than 45° or at a rotational speed of not less than 200 rpm when the contact angle of the replacement liquid with respect to the surface of the substrate is less than 35°.

Thus, even when the contact angle of the processing liquid, remaining on the surface of the substrate, with respect to the surface of the substrate is not less than 45°, the formation of watermarks on the surface of the substrate after drying can be prevented by replacing the processing liquid with a replacement liquid having a contact angle of less than 45° with respect to the surface of the substrate, and then drying the substrate by rotating the substrate at a predetermined rotational speed as described above.

According to the substrate processing method of the present invention, a surface of a substrate, which has hydrophobic properties, can be kept completely wet with a processing liquid. This can prevent partial drying of the surface of the substrate during a later drying step, thereby preventing the formation of watermarks on the surface of the substrate after drying.

### BRIEF DESCRIPTION OF THE DRAWINGS

FIG. 1 is a graph showing those relations between the rotational speed of a substrate and the flow rate of a processing liquid which are necessary to completely wet a surface of the substrate with the processing liquid, as determined experimentally for varying contact angles θ (30°, 45°, 60° and)75° of the processing liquid with respect to the surface of the substrate;

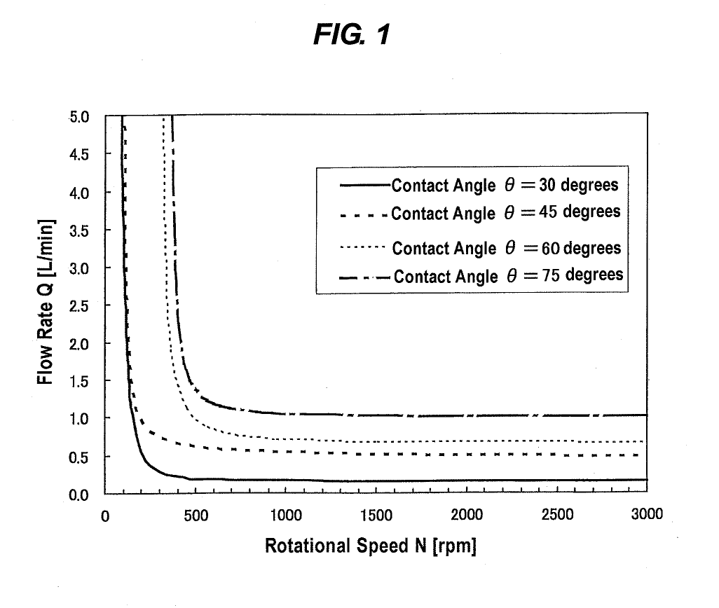

FIG. 2 is a graph showing three different types of the behavior of a processing liquid on a surface of a substrate upon drying of the surface of the substrate by rotating the substrate after processing with the processing liquid, determined by a relationship between the rotational speed of the substrate and the contact angle of the processing liquid with respect to the surface of the substrate;

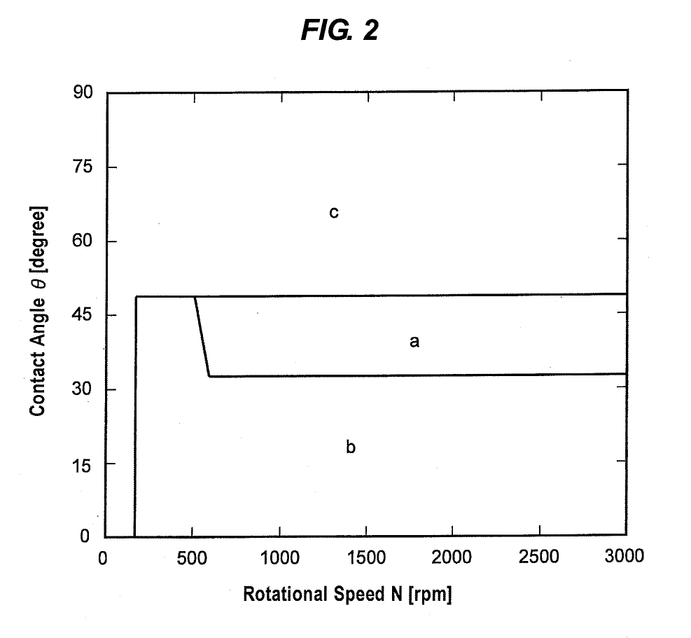

FIG. 3 is a flow chart showing the basic steps of an exemplary substrate processing process according to the present invention;

FIG. 4 is a schematic view of an exemplary substrate processing apparatus for carrying out a substrate processing method according to the present invention;

FIG. 5 is a diagram showing the pivot area of a liquid supply arm provided in the substrate processing apparatus shown in FIG. 4;

FIG. 6 is a flow chart showing a first embodiment in which a substrate is processed according to a processing recipe appropriate for prevention of partial draining of a processing liquid on a surface of the substrate or partial drying of the surface of the substrate;

FIG. 7 is a graph showing change of the flow rate of a processing liquid and change of the rotational speed of a substrate in the first embodiment shown in FIG. 6;

FIG. 8 is a flow chart showing a second embodiment in which a substrate is processed according to a processing recipe appropriate for prevention of partial draining of a processing liquid on a surface of the substrate or partial drying of the surface of the substrate; and

FIG. 9 is a graph showing change of the flow rate of a processing liquid and change of the rotational speed of a substrate in the second embodiment shown in FIG. 8.

### DETAILED DESCRIPTION OF THE PREFERRED EMBODIMENTS

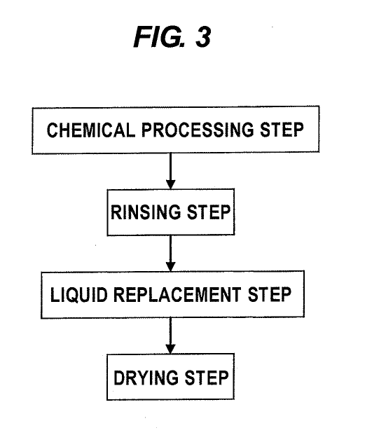

Preferred embodiments of the present invention will now be described in detail with reference to the drawings. FIG. 3 shows the basic steps of an exemplary substrate processing process according to the present invention.

As shown in FIG. 3, chemical processing of a surface of a substrate is carried out by, for example, supplying a liquid chemical such as a cleaning liquid to a central portion of the surface of the substrate rotating horizontally (chemical processing step). The chemical processing step may be a scrub cleaning step in which a surface of a substrate is scrub-cleaned in the presence of a cleaning liquid (liquid chemical). Alternatively, the chemical processing step may be another wet processing step, such as a two-fluid jet cleaning step, a cavitation jet processing step or a spray cleaning step.

To remove the liquid chemical remaining on the surface of the substrate after the chemical processing step, rinsing of the surface of the substrate is carried out by supplying a rinsing liquid, such as pure water, to the central portion of the surface of the substrate rotating horizontally (rinsing step). In the rinsing step, the rotational speed of the substrate and the flow rate of the rinsing liquid when supplied to the substrate are determined depending on the contact angle of the rinsing liquid with respect to the surface of the substrate. Besides pure water, it is possible to use deionized water (DIW), carbonated water, hydrogen-containing water, or the like as the rinsing liquid.

In particular, when the contact angle of the rinsing liquid with respect to the surface of the substrate is not more than 30°, the rotational speed N (rpm) of the substrate and the flow rate Q (L/min) of the rinsing liquid when supplied to the surface of the substrate are determined such that they satisfy the following relation:

Q>30000×(N−35)^{-2.2}+0.15

When the contact angle of the rinsing liquid with respect to the surface of the substrate is not more than 45°, the rotational speed N (rpm) of the substrate and the flow rate Q (L/min) of the rinsing liquid when supplied to the surface of the substrate are determined such that they satisfy the following relation:

Q>20×(N−100)^{-0 8}+0.45

When the contact angle of the rinsing liquid with respect to the surface of the substrate is not more than 60°, the rotational speed N (rpm) of the substrate and the flow rate Q (L/min) of the rinsing liquid when supplied to the surface of the substrate are determined such that they satisfy the following relation:

Q>37000×(N−250)^{-1.7}+0.65

When the contact angle of the rinsing liquid with respect to the surface of the substrate is not more than 75°, the rotational speed N (rpm) of the substrate and the flow rate Q (L/min) of the rinsing liquid when supplied to the surface of the substrate are determined such that they satisfy the following relation:

Q>790×(N−330)^{-1.5}+1

By thus determining the rotational speed of the substrate and the flow rate of the rinsing liquid when supplied to the surface of the substrate depending on the contact angle of the rinsing liquid with respect to the surface of the substrate, the surface of the substrate can be kept completely wet with the rinsing liquid.

After the rinsing step, a liquid replacement step for replacing the rinsing liquid on the surface of the substrate with a replacement liquid is optionally carried out by supplying a replacement liquid whose contact angle with respect to the surface of the substrate is smaller than the rinsing liquid, such as an aqueous solution of IPA (isopropyl alcohol), to the central portion of the surface of the substrate rotating horizontally. Besides an IPA solution, a solution containing at least one of methanol, ethanol, acetone, HFE (hydrofluoroether) and MEK (methyl ethyl ketone) may be used as the replacement liquid. An aqueous solution of IPA is preferred from the viewpoint of impurities and cost.

After the liquid replacement step, spin-drying of the surface of the substrate is carried out by rotating the substrate at a high speed (drying step). In this case, the replacement liquid used in the preceding liquid replacement step preferably has a contact angle of less than 45°, more preferably less than 35° with respect to the surface of the substrate.

When the contact angle of the replacement liquid with respect to the surface of the substrate is not less than 35° and less than 45°, the substrate is preferably rotated in the drying step at a rotational speed of not less than 600 rpm. Such a rotational speed of the substrate allows a liquid film on the surface of the substrate to be drained off without its change into liquid droplets during the spin-drying. This can prevent the formation of watermarks on the surface of the substrate after drying. When the contact angle of the replacement liquid with respect to the surface of the substrate is less than 35°, the substrate is preferably rotated in the drying step at a rotational speed of not less than 200 rpm. Such a rotational speed of the substrate allows a liquid film on the surface of the substrate to be drained off without its change into liquid droplets during the spin-drying. This can prevent the formation of watermarks on the surface of the substrate after drying.

Therefore, when the contact angle of the rinsing liquid, remaining on the surface of the substrate, with respect to the surface of the substrate is not less than 45°, the liquid replacement step and the drying step are preferably carried out in the following manner: The rinsing liquid remaining on the surface of the substrate is replaced with a replacement liquid having a contact angle of less than 45° with respect to the surface of the substrate. When the contact angle of the replacement liquid with respect to the surface of the substrate is not less than 35° and less than 45°, the surface of the substrate is dried by rotating the substrate at a rotational speed of not less than 600 rpm. When the contact angle of the replacement liquid with respect to the surface of the substrate is less than 35°, the surface of the substrate is dried by rotating the substrate at a rotational speed of not less than 200 rpm.

Thus, even when the contact angle of the rinsing liquid, remaining on the surface of the substrate, with respect to the surface of the substrate is not less than 45°, the formation of watermarks on the surface of the substrate after drying can be prevented by replacing the rinsing liquid with a replacement liquid having a contact angle of less than 45° with respect to the surface of the substrate, and then drying the substrate by rotating the substrate at a predetermined rotational speed as described above.

The contact angle of the rinsing liquid with respect to the surface of the substrate may be measured either in advance or in a contact angle measurement step carried out after the chemical processing step and before the rinsing step.

The liquid replacement step is not indispensable. For example, when the contact angle of the rinsing liquid with respect to the surface of the substrate is not less than 35° and less than 45°, the substrate may be spin-dried, immediately after the rinsing step and without carrying out the liquid replacement step, by rotating the substrate at a rotational speed of not less than 600 rpm. This also allows a liquid film on the surface of the substrate to be drained off without its change into liquid droplets during the spin-drying, thereby preventing the formation of watermarks on the surface of the substrate after drying. When the contact angle of the rinsing liquid with respect to the surface of the substrate is less than 35°, the substrate may be spin-dried, immediately after the rinsing step and without carrying out the liquid replacement step, by rotating the substrate at a rotational speed of not less than 200 rpm. This also allows a liquid film on the surface of the substrate to be drained off without its change into liquid droplets during the spin-drying, thereby preventing the formation of watermarks on the surface of the substrate after drying.

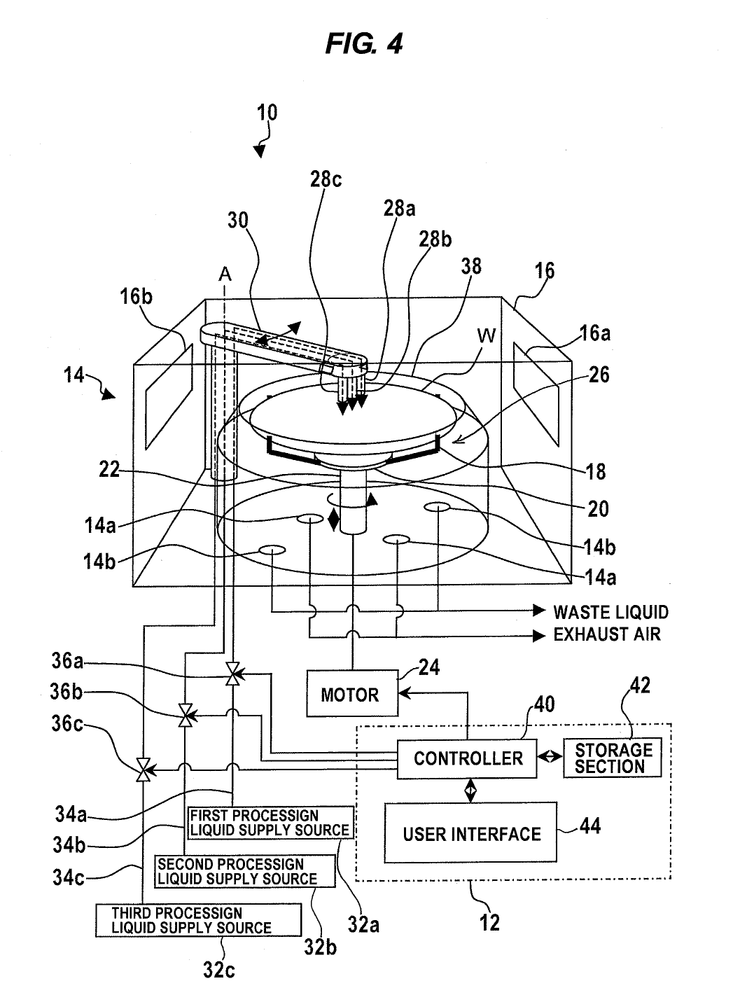

FIG. 4 shows an exemplary substrate processing apparatus for carrying out a substrate processing method according to the present invention. The substrate processing apparatus is configured to clean a surface of a substrate, which has been subjected to chemical mechanical polishing (CMP), with a cleaning liquid (liquid chemical), rinse the surface of the substrate with a rinsing liquid after the cleaning, and then dry the surface of the substrate.

The substrate processing apparatus comprises an apparatus body 10 and a control section 12 for controlling the components of the apparatus body 10. The apparatus body 10 has a loading section 16a for carrying a substrate W into a processing chamber 14, and an unloading section 16b for carrying the substrate W out of the processing chamber 14. The processing chamber 14 is isolated from the outside by a partition wall 16 defining the processing chamber 14. The loading section 16a includes a shutter (not shown) which is opened when carrying the substrate W into the processing chamber 14. The unloading section 16b includes a shutter (not shown) which is opened when carrying the substrate W out of the processing chamber 14. To the ceiling of the processing chamber 14 is connected a fan/filter unit (not shown) for supplying clean air into the processing chamber 14. Exhaust holes 14a for discharging air from the processing chamber 14 are provided at the bottom of the processing chamber 14.

In the processing chamber 14 is disposed a substrate holding/rotating section 26 which includes a holder 18, a holder fixing plate 20 and a shaft 22 and which holds and rotates the substrate W in a horizontal position by a motor 24 located outside the processing chamber 14. The substrate holding/rotating section 26 also includes a lifting mechanism (not shown) for vertically moving the substrate W.

In the processing chamber 14 is disposed a liquid supply arm 30 having a liquid supply section consisting of a first processing liquid supply nozzle 28a, a second processing liquid supply nozzle 28b and a third processing liquid supply nozzle 28c. The first processing liquid supply nozzle 28a is connected to a first processing liquid supply line 34a extending from a first processing liquid supply source 32a located outside the processing chamber 14, and supplies a first processing liquid to the surface (upper surface) of the substrate W. The second processing liquid supply nozzle 28b is connected to a second processing liquid supply line 34b extending from a second processing liquid supply source 32b located outside the processing chamber 14, and supplies a second processing liquid to the surface (upper surface) of the substrate W. The third processing liquid supply nozzle 28c is connected to a third processing liquid supply line 34c extending from a third processing liquid supply source 32c located outside the processing chamber 14, and supplies a third processing liquid to the surface (upper surface) of the substrate W.

In this embodiment, a cleaning liquid (liquid chemical), such as hydrofluoric acid, is used as the first processing liquid; a rinsing liquid, such as pure water, is used as the second processing liquid; and a replacement liquid, such as an aqueous solution of IPA, is used as the third processing liquid.

The first processing liquid supply line 34a is provided with a flow control valve 36a for performing on/off control of the supply of the processing liquid and, in addition, independently controlling the flow rate of the processing liquid. Similarly, the second processing liquid supply line 34b and third processing liquid supply line 34c are provided with a flow control valve 36b and a flow control valve 36c, respectively. The substrate processing apparatus includes a pivot mechanism (not shown) configured to allow the liquid supply arm 30 to pivot on an axis A.

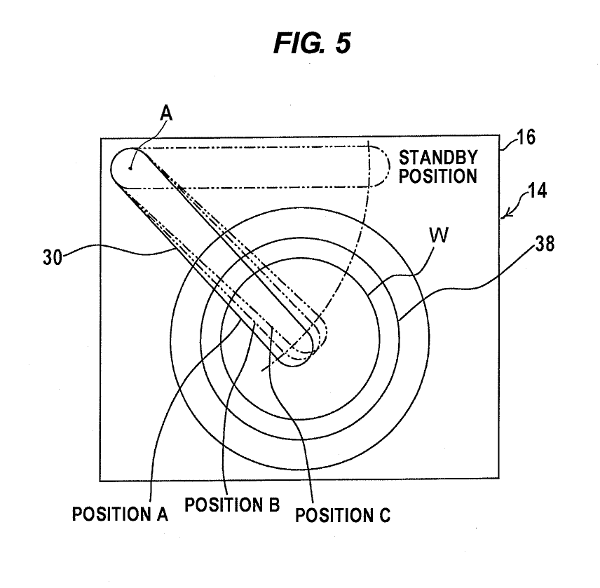

FIG. 5 shows the pivot area of the liquid supply arm 30. The liquid supply arm 30 is positioned at a first processing liquid supply position A (hereinafter simply referred to as “position A”) when supplying the first processing liquid, positioned at a second processing liquid supply position B (hereinafter simply referred to as “position B”) when supplying the second processing liquid, and positioned at a third processing liquid supply position C (hereinafter simply referred to as “position C”) when supplying the third processing liquid. The liquid supply arm 30, in any of the positions A to C, supplies the processing liquid to a central portion of the surface of the substrate W. The liquid supply arm 30 is in a standby position when no processing liquid is supplied to the substrate W from the liquid supply section.

Returning to FIG. 4, a liquid scattering prevention cup 38 is installed in the processing chamber 14 in order to recover a processing liquid that has been supplied from the liquid supply section to a rotating substrate W, without allowing the processing liquid to scatter in the processing chamber 14. The processing liquid that has been recovered in the liquid scattering prevention cup 38 is discharged to the outside of the processing chamber 14 from liquid discharge holes 14b provided in the bottom of the processing chamber 14.

The control section 12 includes a controller 40 for controlling the components of the apparatus body 10, a storage section 42 for storing a processing recipe, etc., and a user interface 44 for inputting a processing recipe, the contact angle of a processing liquid with respect to a surface of a substrate, etc.

The controller 40, based on a processing recipe, controls the components of the apparatus body 10, i.e., the motor 24, the flow control valves 36a-36c, the pivot mechanism for the liquid supply arm 30, the substrate holding mechanism of the holder 18, the lifting mechanism of the substrate holding/rotating section 26, the shutters of the loading section 16a and the unloading section 16b, etc., and also controls the storage section 42 and the user interface 44. The controller 40 may also control other not-shown unit(s) and/or a not-shown substrate transport device, and may communicate with a controller of another not-shown control section.

The storage section 42 stores a plurality of processing recipes according to which the controller 40 controls the components of the apparatus body 10 to process a substrate W. The storage section 42 may also store a contact angle database containing information on types of surface films of a substrate W, types of processing liquids to be supplied to the surface of the substrate W, and the contact angles of each processing liquid at varying concentrations with respect to the surface of the substrate. An exemplary processing recipe to be stored in the storage section 42 is shown in Table 1 below.

TABLE 1

| | Unit | Step 1 | Step 2 | Step 3 | Step 4 |
|---|---|---|---|---|---|
| Position of liquid | | Position A | Position B | Position C | Standby |
| supply arm | | | | | position |
| Flow rate of first | L/min | 0.5 | 0 | 0 | 0 |
| processing liquid | | | | | |
| Flow rate of | L/min | 0 | 1 | 0 | 0 |
| second processing | | | | | |
| liquid | | | | | |
| Flow rate of third | L/min | 0 | 0 | 0.25 | 0 |
| processing liquid | | | | | |
| Substrate | rpm | 500 | 800 | 800 | 2000 |
| rotational speed | | | | | |
| Processing time | sec | 10 | 20 | 5 | 30 |

The user interface 44 is used to input, prior to the start of processing by the substrate processing apparatus, processing recipes or information on the contact angle of a processing liquid, which is to be supplied to a surface of a substrate W, with respect to the surface of the substrate. Based on the inputted information from the user interface 44 on the contact angle of the processing liquid with respect to the surface of the substrate, i.e. on the combination of the surface of the substrate W and the contact angle of the processing liquid with respect to the surface of the substrate, the controller 40 selects an appropriate processing recipe from the processing recipes stored in the storage section 42 and controls the components of the apparatus body 10.

The user interface 44 may also be used to input or select, prior to the start of processing by the substrate processing apparatus, the type of a surface film of a substrate W, and the type and the concentration of a processing liquid to be supplied to the surface of the substrate W. The controller 40 then extracts the contact angle of the processing liquid, determined by the type of the surface film of the substrate W and the type and the concentration of the processing liquid, from the contact angle database containing information on types of surface films of a substrate W, types of processing liquids to be supplied to the surface of the substrate W, and the contact angles of each processing liquid at varying concentrations with respect to the surface of the substrate, stored in the storage section 42. Further, the controller 40 selects an appropriate processing recipe from the processing recipes stored in the storage section 42, and controls the components of the apparatus body 10.

When inputting a processing recipe from the user interface 44, the controller 40 may assist the user in inputting the processing recipe by using the contact angle database containing information on types of surface films of a substrate W, types of processing liquids to be supplied to the surface of the substrate W, and the contact angles of each processing liquid at varying concentrations with respect to the surface of the substrate. For example, the user selects from a list the type of a surface film of a substrate W, and the type and the concentration of a processing liquid. The controller 40 then extracts a corresponding contact angle from the contact angle database stored in the storage section 42, extracts recommended set values for the flow rate of the processing liquid and the rotational speed of the substrate, depending on the extracted contact angle of the processing liquid, from a database of recommended set values for the flow rate of a processing liquid and the rotational speed of a substrate, and displays the extracted recommended set values for the flow rate of the processing liquid and the rotational speed of the substrate on the user interface 44. A plurality of recommended set values may be displayed for each item. Thus, the user can input a processing recipe, using the recommended set values.

The contact angle database containing the contact angles of processing liquids (cleaning liquids) with respect to surfaces of substrates may contain, in addition to information on the types of surface films of a substrate W and the types and concentrations of the processing liquids, information on the history of processing carried out prior to processing by the present substrate processing apparatus. The contact angle of a processing liquid with respect to a surface of a substrate may vary depending on the history of processing carried out prior to processing by the present substrate processing apparatus. Therefore, by adding information on the history of such prior processing to the contact angle database so that the history will be reflected in the present processing, a more accurate data on the contact angle of a processing liquid with respect to a surface of a substrate can be extracted from the contact angle database.

In this embodiment, a substrate W can be processed according to a processing recipe which is determined depending on the contact angle of a processing liquid, to be supplied to the surface of the substrate W, with respect to the surface of the substrate and which is appropriate for prevention of partial draining of the processing liquid on the surface of the substrate or partial drying of the surface of the substrate. The processing recipe can be obtained or prepared by (1) inputting from the user interface 44 the contact angle of the processing liquid with respect to the surface of the substrate W, (2) inputting or selecting from the user interface 44 the type of a surface film of the substrate W, and the type and the concentration of the processing liquid to be supplied to the surface of the substrate W, or (3) using the contact angle database stored in the storage section 42 when inputting the processing recipe from the user interface 44.

In particular, when the contact angle of the processing liquid with respect to the surface of the substrate W is not more than 30°, the substrate W is processed according to a processing recipe in which the rotational speed N (rpm) of the substrate and the flow rate Q (L/min) of the processing liquid when supplied to the surface of the substrate satisfy the following relation:

Q>30000×(N−35)^{-2.2}+0.15

When the contact angle of the processing liquid with respect to the surface of the substrate W is not more than 45°, the substrate W is processed according to a processing recipe in which the rotational speed N (rpm) of the substrate and the flow rate Q (L/min) of the processing liquid when supplied to the surface of the substrate satisfy the following relation:

Q>20×(N−100)^{-0.8}+0.45

When the contact angle of the processing liquid with respect to the surface of the substrate W is not more than 60°, the substrate W is processed according to a processing recipe in which the rotational speed N (rpm) of the substrate and the flow rate Q (L/min) of the processing liquid when supplied to the surface of the substrate satisfy the following relation:

Q>37000×(N−250)^{-1.7}+0.65

When the contact angle of the processing liquid with respect to the surface of the substrate W is not more than 75°, the substrate W is processed according to a processing recipe in which the rotational speed N (rpm) of the substrate and the flow rate Q (L/min) of the processing liquid when supplied to the surface of the substrate satisfy the following relation:

Q>790×(N−330)^{-1.5}+1

When the contact angle of the processing liquid, remaining on the surface of the substrate, with respect to the surface of the substrate W is not less than 35° and less than 45°, the substrate W is processed according to a processing recipe in which the rotational speed of the substrate W upon drying (spin-drying) of the surface of the substrate W is set at a value of not less than 600 rpm.

When the contact angle of the processing liquid, remaining on the surface of the substrate, with respect to the surface of the substrate W is less than 35°, the substrate W is processed according to a processing recipe in which the rotational speed of the substrate W upon drying (spin-drying) of the surface of the substrate W is set at a value of not less than 200 rpm.

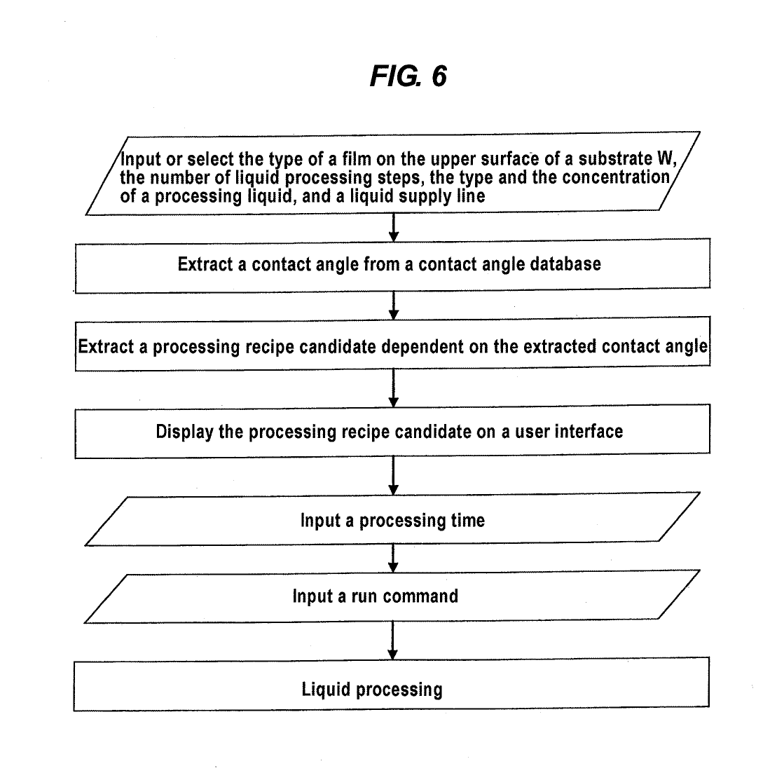

A first embodiment will now be described with reference to the flow chart shown in FIG. 6. In this embodiment, a substrate W is processed according to a processing recipe which is determined depending on the contact angle of a processing liquid, to be supplied to the surface of the substrate W, with respect to the surface of the substrate and which is appropriate for prevention of partial draining of the processing liquid on the surface of the substrate or partial drying of the surface of the substrate; the processing recipe is obtained or prepared by selecting from the user interface 44 the type of a surface film of the substrate W, and the type and the concentration of the processing liquid.

In this embodiment, the contact angle of the processing liquid (pure water), remaining on the surface of the substrate W upon drying of the substrate W, with respect to the surface of the substrate W is 20°. Accordingly, the liquid replacement step shown in FIG. 3, which is carried out when the processing liquid has a contact angle of not less than 45°, is not carried out before drying (spin-drying) the surface of the substrate W by rotating the substrate W.

First, using the user interface 44, the user selects the type of a surface film of the substrate W from a prepared list of types of films, inputs the number of processing steps, selects the type and the concentration of a processing liquid to be used in each step from a list of types and concentrations of processing liquids, and selects a liquid supply line to be used in each step. The controller 40 then extracts the type of the selected surface film of the substrate W and the contact angle of the processing liquid, determined by the type of the surface film of the substrate W and the type and the concentration of the processing liquid, from the contact angle database stored in the storage section 42. The extracted contact angle may be displayed on the user interface 44.

Depending on the extracted contact angle, the controller 40 extracts an appropriate combination of the flow rate of the processing liquid and the rotational speed of the substrate from a number of their combinations stored in the storage section 42, and displays on the user interface 44 the extracted combination as a candidate for a processing recipe. The controller 40 may extract a plurality of processing recipes and display them on the user interface 44 so that the user can select a processing recipe.

Next, the user inputs the processing time for each step from the user interface 44, thereby completing the processing recipe. An example of the thus-obtained processing recipe is shown in Table 2 below.

TABLE 2

| | Unit | Step 1 | Step 2 | Step 3 |
|---|---|---|---|---|
| Position of liquid | | Position A | Position B | Standby position |
| supply arm | | | | |
| Flow rate of first | L/min | 0.5 | 0 | 0 |
| Processing liquid | | | | |
| Flow rate of second | L/min | 0 | 0.5 | 0 |
| processing liquid | | | | |
| Flow rate of third | L/min | 0 | 0 | 0 |
| processing liquid | | | | |
| Substrate | Rpm | 500 | 600 | 1000 |
| rotational speed | | | | |
| Processing time | Sec | 20 | 20 | 30 |

In the exemplary processing recipe shown in Table 2, the surface film of the substrate W is, for example, a thermally-oxidized film, and the number of liquid processing steps is two. The type and the concentration of each of the processing liquids to be used in the respective steps are: a liquid chemical (concentration X %) in step 1; and pure water in step 2. The liquid supply lines to be used in the respective steps are: the first processing liquid supply line 34a in step 1; and the second processing liquid supply line 34b in step 2.

Upon the completion of input of the above information, the controller 40 first extracts 10° as the contact angle of the liquid chemical (concentration X %), to be used in step 1, with respect to the thermally-oxidized film, and then extracts a liquid flow rate of 0.5 L/min and a substrate rotational speed of 500 rpm as processing conditions that depend on the contact angle 10°. Next, the controller 40 extracts 20° as the contact angle of pure water, to be used in step 2, with respect to the thermally-oxidized film, and then extracts a liquid flow rate of 0.5 L/min and a substrate rotational speed of 600 rpm as processing conditions that depend on the contact angle 20°.

Next, the controller 40 adds a drying step as step 3, and extracts 20° as the contact angle of pure water with respect to the thermally-oxidized film and then extracts a substrate rotational speed of 1000 rpm as drying conditions that depend on the contact angle 20°. The controller 40 then displays on the user interface 44 a candidate(s) for a processing recipe that reflects the extracted liquid flow rate and the extracted substrate rotational speed for each step. Next, the user inputs the processing time for each step from the user interface 44, thereby completing the processing recipe. A drying step will not be carried out if 0 second is inputted as the processing time for step 3.

Though a liquid supply line to be used is selected by the user by the user interface 44 in the above-described process for the preparation of the processing recipe shown in Table 2, a liquid supply line may be selected by the controller 40 depending on a selected processing liquid. Further, though a drying step is added by the controller 40 in the above-described process, it is also possible for the user to choose whether or not to add a drying step by the user interface 44.

Next, the user inputs a run command into the controller 40 by the user interface 44, whereby the controller 40 starts liquid processing. The number of substrates to be processed, etc. may be inputted from the user interface 44 before inputting the run command.

The flow of processing in the substrate processing apparatus shown in FIGS. 4 and 5, performed according to the processing recipe shown in Table 2 after the input of the run command, will now be described.

The controller 40 opens the shutter of the loading section 16a and raises the substrate holding/rotating section 26 to a substrate transfer position, and then carries a substrate W into the processing chamber 14 by a transport robot (not shown) and sets the substrate W in the holder 18. Next, the controller 40 closes the shutter of the loading section 16a and causes the holder 18 to hold the substrate W by the substrate holding mechanism, and then lowers the substrate holding/rotating section 26 to a processing position.

Next, the controller 40 pivots the liquid supply arm 30 to the position A and rotates the substrate W at 500 rpm. The rotational speed of the substrate W is controlled by controlling the rotational speed of the motor 24. Thereafter, while rotating the substrate W, the controller 40 supplies a first processing liquid (liquid chemical) from the first processing liquid supply nozzle 28a to the surface (upper surface) of the substrate W while controlling the flow rate of the first processing liquid at 0.5 L/min by the flow control valve 36a (step 1).

When a processing time of 20 seconds has elapsed, the controller 40 stops the supply of the first processing liquid (liquid chemical) by the flow control valve 36a, pivots the liquid supply arm 30 to the position B and adjusts the rotational speed of the substrate W to 600 rpm. While rotating the substrate W at 600 rpm, the controller 40 supplies a second processing liquid (pure water) from the second processing liquid supply nozzle 28b to the surface of the substrate W while controlling the flow rate of the second processing liquid at 0.5 L/min by the flow control valve 36b (step 2).

When a processing time of 20 seconds has elapsed, the controller 40 stops the supply of the second processing liquid (pure water) by the flow control valve 36b and pivots the liquid supply arm 30 to the standby position. The controller 40 adjusts the rotational speed of the substrate W to 1000 rpm and rotates the substrate W to dry the surface of the substrate W (step 3). When a processing time of 30 seconds has elapsed, the controller 40 stops the rotation of the substrate W.

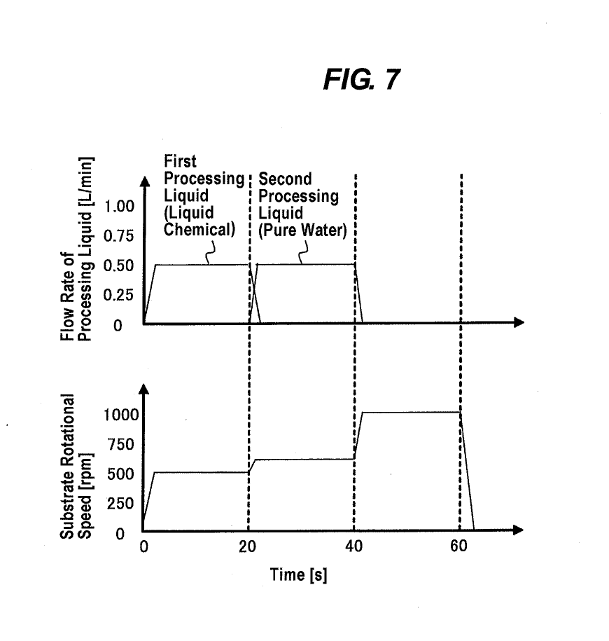

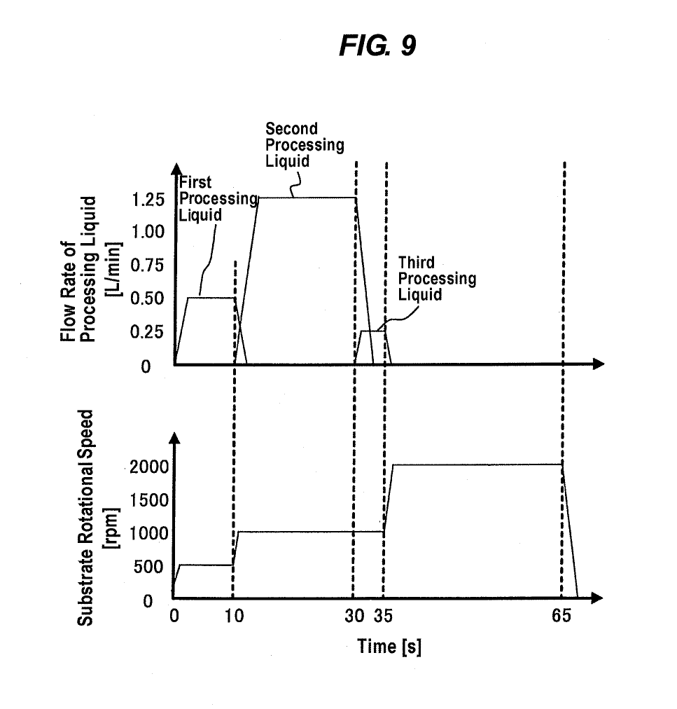

FIG. 7 shows change of the flow rate of the processing liquid and change of the rotational speed of the substrate during the steps 1 to 3 in the first embodiment. In FIG. 7, the time 0 represents the time at which the supply of the first processing liquid (liquid chemical) is started. Because the substrate W starts to rotate before the start of the supply of the first processing liquid (liquid chemical), the rotational speed of the substrate W is not 0 rpm at time 0. This holds true for the below-described FIG. 9.

Next, the controller 40 opens the shutter of the unloading section 16b and raises the substrate holding/rotating section 26 to the substrate transfer position, and then carries the substrate W out of the processing chamber 14 by the transport robot (not shown). Next, the controller 40 closes the shutter of the unloading section 16b and lowers the substrate holding/rotating section 26 to the processing position.

In the case where a plurality of substrates are processed in a successive manner, the following operation may be performed: The shutter of the unloading section 16b and the shutter of the loading section 16a are opened simultaneously after the completion of processing (drying) in step 3. Immediately after carrying a processed substrate out of the processing chamber 14, an unprocessed substrate is carried from the loading section 16a into the processing chamber 14 and set in the holder 18. The substrate is then subjected to the above-described processing steps.

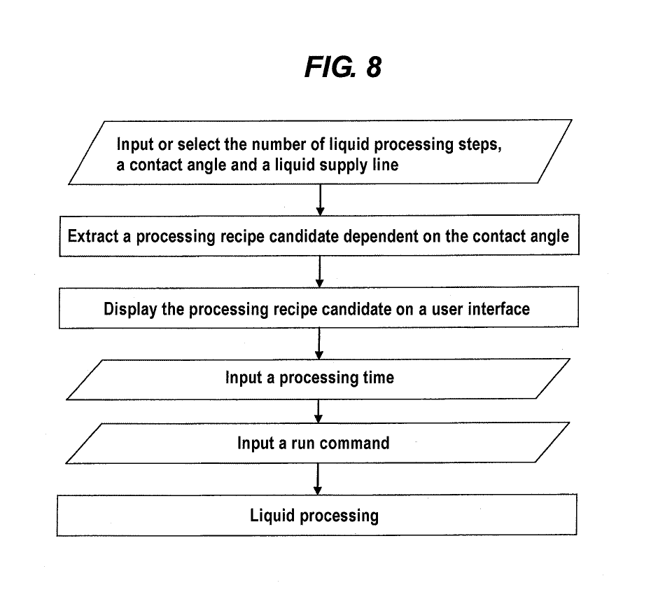

A second embodiment will now be described with reference to the flow chart shown in FIG. 8. In this embodiment, a substrate W is processed according to a processing recipe which is determined depending on the contact angle of a processing liquid, to be supplied to the surface of the substrate W, with respect to the surface of the substrate and which is appropriate for prevention of partial draining of the processing liquid on the surface of the substrate or partial drying of the surface of the substrate; the processing recipe is obtained or prepared by inputting from the user interface 44 the contact angle of the processing liquid with respect to the surface of the substrate W.

In this embodiment, the contact angle of the processing liquid (pure water), remaining on the surface of the substrate W upon drying (spin-drying) of the substrate W, with respect to the surface of the substrate W is 70°. Accordingly, the liquid replacement step shown in FIG. 3, which is carried out when the processing liquid has a contact angle of not less than 45°, is carried out before drying (spin-drying) the surface of the substrate W by rotating the substrate W. Thus, the processing liquid (pure water) remaining on the surface of the substrate is replaced with a replacement liquid having a contact angle of less than 45°, which is 10° in this embodiment, with respect to the surface of the substrate.

First, using the user interface 44, the user inputs the number of liquid processing steps, inputs the contact angle of each of processing liquids, to be used in the respective steps, with respect to the surface of the substrate W, and selects a liquid supply line to be used in each step. Depending on the inputted contact angle, the controller 40 extracts an appropriate combination of the flow rate of the processing liquid and the rotational speed of the substrate from a number of their combinations stored in the storage section 42, and displays on the user interface 44 the extracted combination as a candidate for a processing recipe. The controller 40 may extract a plurality of processing recipes and display them on the user interface 44 so that the user can select a processing recipe.

Next, the user inputs the processing time for each step from the user interface 44, thereby completing the processing recipe. An example of the thus-obtained processing recipe is shown in Table 3 below.

TABLE 3

| | Unit | Step 1 | Step 2 | Step 3 | Step 4 |
|---|---|---|---|---|---|
| Position of liquid | | Position A | Position B | Position C | Standby |
| supply arm | | | | | position |
| Flow rate of first | L/min | 0.5 | 0 | 0 | 0 |
| processing liquid | | | | | |
| Flow rate of | L/min | 0 | 1.25 | 0 | 0 |
| second processing | | | | | |
| liquid | | | | | |
| Flow rate of third | L/min | 0 | 0 | 0.25 | 0 |
| processing liquid | | | | | |
| Substrate | Rpm | 500 | 1000 | 800 | 2000 |
| rotational speed | | | | | |
| Processing time | Sec | 10 | 20 | 5 | 30 |

In the exemplary processing recipe shown in Table 3, the surface film of the substrate W is, for example, a thermally-oxidized film, and the number of liquid processing steps is three. The contact angles of the processing liquids, to be used in the respective steps, with respect to the surface of the substrate W are: 20° in step 1; 70° in step 2; and 10° in step 3. The liquid supply lines to be used in the respective steps are: the first processing liquid supply line 34a in step 1; the second processing liquid supply line 34b in step 2; and the third processing liquid supply line 34c in step 3.

Upon the completion of input of the above information, the controller 40 extracts a processing recipe that depends on the combination of the contact angles of the processing liquids, to be used in the respective steps, with respect to the surface of the substrate W. The processing recipe uses the following processing conditions: the flow rate of the processing liquid is 0.5 L/min and the rotational speed of the substrate is 500 rpm in step 1; the flow rate of the processing liquid is 1.25 L/min and the rotational speed of the substrate is 1000 rpm in step 2; the flow rate of the processing liquid is 0.25 L/min and the rotational speed of the substrate is 800 rpm in step 3; and the rotational speed of the substrate is 2000 rpm in step 4 (drying step). The controller 40 then displays the extracted candidate for a processing recipe on the user interface 44. Next, the user inputs the processing time for each step from the user interface 44, thereby completing the processing recipe. As with the first embodiment, a drying step will not be carried out if 0 second is inputted as the processing time for step 4.

Next, the user inputs a run command into the controller 40 by the user interface 44, whereby the controller 40 starts liquid processing. The number of substrates to be processed, etc. may be inputted from the user interface 44 before inputting the run command.

The flow of processing in the substrate processing apparatus shown in FIGS. 4 and 5, performed according to the processing recipe shown in Table 3 after the input of the run command, will now be described.

The controller 40 opens the shutter of the loading section 16a and raises the substrate holding/rotating section 26 to a substrate transfer position, and then carries a substrate W into the processing chamber 14 by a transport robot (not shown) and sets the substrate W in the holder 18. Next, the controller 40 closes the shutter of the loading section 16a and causes the holder 18 to hold the substrate W by the substrate holding mechanism, and then lowers the substrate holding/rotating section 26 to a processing position.

Next, the controller 40 pivots the liquid supply arm 30 to the position A and rotates the substrate W at 500 rpm. The rotational speed of the substrate W is controlled by controlling the rotational speed of the motor 24. Thereafter, while rotating the substrate W, the controller 40 supplies a first processing liquid (liquid chemical) from the first processing liquid supply nozzle 28a to the surface of the substrate W while controlling the flow rate of the first processing liquid at 0.5 L/min by the flow control valve 36a (step 1).

When a processing time of 10 seconds has elapsed, the controller 40 stops the supply of the first processing liquid (liquid chemical) by the flow control valve 36a, pivots the liquid supply arm 30 to the position B and adjusts the rotational speed of the substrate W to 1000 rpm. While rotating the substrate W at 1000 rpm, the controller 40 supplies a second processing liquid (pure water) from the second processing liquid supply nozzle 28b to the surface of the substrate W while controlling the flow rate of the second processing liquid at 1.25 L/min by the flow control valve 36b (step 2).

When a processing time of 20 seconds has elapsed, the controller 40 stops the supply of the second processing liquid (pure water) by the flow control valve 36b, pivots the liquid supply arm 30 to the position C and adjusts the rotational speed of the substrate W to 800 rpm. While rotating the substrate W at 800 rpm, the controller 40 supplies a third processing liquid (replacement liquid) from the third processing liquid supply nozzle 28c to the surface of the substrate W while controlling the flow rate of the third processing liquid at 0.25 L/min by the flow control valve 36c (step 3).

When a processing time of 5 seconds has elapsed, the controller 40 stops the supply of the third processing liquid (replacement liquid) by the flow control valve 36c and pivots the liquid supply arm 30 to the standby position. The controller 40 adjusts the rotational speed of the substrate W to 2000 rpm and rotates the substrate W to dry the surface of the substrate W (step 4). When a processing time of 30 seconds has elapsed, the controller 40 stops the rotation of the substrate W.

FIG. 9 shows change of the flow rate of the processing liquid and change of the rotational speed of the substrate during the steps 1 to 4 in the second embodiment.

Next, the controller 40 opens the shutter of the unloading section 16b and raises the substrate holding/rotating section 26 to the substrate transfer position, and then carries the substrate W out of the processing chamber 14 by the transport robot (not shown). Next, the controller 40 closes the shutter of the unloading section 16b and lowers the substrate holding/rotating section 26 to the processing position.

As with the first embodiment, in the case where a plurality of substrates are processed in a successive manner, the following operation may be performed: The shutter of the unloading section 16b and the shutter of the loading section 16a are opened simultaneously after the completion of processing (drying) in step 4. Immediately after carrying a processed substrate out of the processing chamber 14, an unprocessed substrate is carried from the loading section 16a into the processing chamber 14 and set in the holder 18. The substrate is then subjected to the above-described processing steps.

While the present invention has been described with reference to preferred embodiments, it is understood that the present invention is not limited to the embodiments described above, but is capable of various changes and modifications within the scope of the inventive concept as expressed herein.

What is claimed is:

1. A substrate processing method for processing a substrate by supplying a processing liquid to a central portion of a surface of the substrate rotating horizontally, said method comprising:
determining the rotational speed of the substrate and the flow rate of the processing liquid when supplied to the surface of the substrate from a relationship between the rotational speed of the substrate and the flow rate of the processing liquid when supplied to the surface of the substrate, said relationship being dependent on the contact angle of the processing liquid with respect to the surface of the substrate and being capable of preventing partial draining of the processing liquid held on the surface of the substrate or partial drying of the surface of the substrate; and
supplying the processing liquid to the central portion of the surface of the substrate at the determined flow rate while rotating the substrate at the determined rotational speed.

2. The substrate processing method according to claim 1, wherein when the contact angle of the processing liquid with respect to the surface of the substrate is not more than 30°, the rotational speed N (rpm) of the substrate and the flow rate Q (L/min) of the processing liquid when supplied to the surface of the substrate satisfy the following relation:
Q>30000×(N−35)^{-2.2}+0.15

3. The substrate processing method according to claim 1, wherein when the contact angle of the processing liquid with respect to the surface of the substrate is not more than 45°, the rotational speed N (rpm) of the substrate and the flow rate Q (L/min) of the processing liquid when supplied to the surface of the substrate satisfy the following relation:
Q>20×(N−100)^{-0.8}+0.45

4. The substrate processing method according to claim 1, wherein when the contact angle of the processing liquid with respect to the surface of the substrate is not more than 60°, the rotational speed N (rpm) of the substrate and the flow rate Q (L/min) of the processing liquid when supplied to the surface of the substrate satisfy the following relation:
Q>37000×(N−250)^{-1.7}+0.65

5. The substrate processing method according to claim 1, wherein when the contact angle of the processing liquid with respect to the surface of the substrate is not more than 75°, the rotational speed N (rpm) of the substrate and the flow rate Q (L/min) of the processing liquid when supplied to the surface of the substrate satisfy the following relation:
Q>790×(N−330)^{-1.5}+1

6. The substrate processing method according to claim 1, wherein the processing liquid is a cleaning liquid for cleaning the surface of the substrate, a rinsing liquid for rinsing off a cleaning liquid remaining on the surface of the substrate after cleaning, or a replacement liquid to be replaced with a rinsing liquid on the surface of the substrate.

7. The substrate processing method according to claim 1, further comprising the step of drying the surface of the substrate after the liquid processing by rotating the substrate.

8. The substrate processing method according to claim 7, wherein when the contact angle of the processing liquid, remaining on the surface of the substrate, with respect to the surface of the substrate is not less than 35° and less than 45°, the substrate is rotated at a rotational speed of not less than 600 rpm in the drying step.

9. The substrate processing method according to claim 7, wherein when the contact angle of the processing liquid, remaining on the surface of the substrate, with respect to the surface of the substrate is less than 35°, the substrate is rotated at a rotational speed of not less than 200 rpm in the drying step.

10. The substrate processing method according to claim 7, wherein when the contact angle of the processing liquid, remaining on the surface of the substrate, with respect to the surface of the substrate is not less than 45°, the processing liquid is replaced with a replacement liquid having a contact angle of less than 45°with respect to the surface of the substrate, and then in the drying step the substrate is rotated either at a rotational speed of not less than 600 rpm when the contact angle of the replacement liquid with respect to the surface of the substrate is not less than 35° and less than 45° or at a rotational speed of not less than 200 rpm when the contact angle of the replacement liquid with respect to the surface of the substrate is less than 35°.
